(19) United States
(12) Patent Application Publication
(10) Pub. No.: US 2008/0022249 A1
(43) Pub. Date: Jan. 24, 2008

(54) EXTENDING POLY-SILICON LINE WITH SUBSTANTIALLY NO CAPACITANCE PENALTY

(76) Inventors: Brent A. Anderson, Jericho, VT (US); Edward J. Nowak, Essex Junction, VT (US)

Correspondence Address: HOFFMAN, WARNICK & D'ALESSANDRO LLC, 75 STATE ST, 14TH FLOOR, ALBANY, NY, 12207, US

(21) Appl. No.: 11/459,206

(22) Filed: Jul. 21, 2006

(51) Int. Cl. G06F 17/50

(52) U.S. Cl. 716/10

(57) ABSTRACT

A structure and method for extending poly-silicon lines to resolve the problem of across chip linewidth variations are provided. A shorter poly-silicon line is extended by an extension line to approximately the same length as a longer neighboring poly-silicon line. The shorter poly-silicon line and the extension line are separated by a gap to eliminate the problem of additional capacitance between the two poly-silicon lines and between the extended shorter poly-silicon line and the respective active area of the substrate. The gap is positioned outside of and adjacent to an edge of the active area.

### BACKGROUND OF THE INVENTION

1. Technical Field

The invention relates generally to integrated circuit design, and more particularly, to a device and method for extending poly-silicon lines to solve the problem of across chip linewidth variation with substantially no additional capacitance.

2. Background Art

Across chip linewidth variation (ACLV) has a significant influence on circuit performance and processing. Under the current state of the art packing density, just a few nanometers in linewidth variation may significantly impact the performance of an integrated circuit (IC). In addition, the different linewidths also cause processing difficulties such as uneven etch loadings. One of the contributions to the ACLV problem is the variation in poly-silicon lines (gate). Traditionally, as shown in FIG. 1, a poly-silicon line 14 extends just beyond the edges of the respective active area 12. On a layout 10 of IC, active area 12 sizes/edges for different devices/components may be different such that poly-silicon lines 14 have different lengths, which causes the ACLV problem.

One approach to combat the ACLV problem caused by layout 10 of FIG. 1 is to extend the neighboring poly-silicon lines 14 to approximately the same length. For example, in FIG. 1, the leftmost poly-silicon line 14a has the longest length. The length of poly-silicon line 14a may be used as a standard for extending other poly-silicon lines 14. As shown in FIG. 2, on layout 110, all poly-silicon lines 114 are fabricated to have approximately the same length as that of the leftmost poly-silicon line 14a of FIG. 1, no matter the location of the edges of the respective active areas 112. Layout 110 of FIG. 2 resolves some of the IC performance problems of ACLV, such as transistor speed/delay differences. In addition, fabrication of layout 110 is less complicated than that of layout 10 of FIG. 1 because lithography or etch loadings for poly-silicon lines 114 (FIG. 2) are more uniform than that for poly-silicon lines 14 (FIG. 1). One disadvantage of layout 110 of FIG. 2 is that the extension from poly-silicon lines 14 (FIG. 1) to poly-silicon lines 114 (FIG. 2) creates additional parasitic capacitances between and among poly-silicon lines 114, between poly-silicon lines 114 and the substrate, and between poly-silicon lines and the active areas 112.

Based on the above, there is a need in the art to create a solution that eliminates the capacitance penalty problem of layout 110 of FIG. 2.

### SUMMARY OF THE INVENTION

A structure and method for extending poly-silicon lines to resolve the problem of across chip linewidth variations are provided. A shorter poly-silicon line is extended by an extension line to approximately the same length as a longer neighboring poly-silicon line. The shorter poly-silicon line and the extension line are separated by a gap to eliminate the problem of additional capacitance between the two poly-silicon lines and between the extended shorter poly-silicon line and the respective active area of the substrate. The gap is positioned outside of and adjacent to an edge of the active area.

A first aspect of the invention provides a semiconductor structure comprising: a poly-silicon line over an active area of a substrate; an extension line longitudinally extending from one end of the poly-silicon line; and a gap separating the poly-silicon line and the extension line, the gap being located outside of and adjacent to an edge of the active area.

A second aspect of the invention provides an integrated circuit surface layout, the layout comprising: a poly-silicon line over an active area of a substrate; an extension line longitudinally extending from one end of the poly-silicon line; and a gap separating the poly-silicon line and the extension line, the gap being located outside of and adjacent to an edge of the active area.

A third aspect of the invention provides a method for substantially unifying linewidths across an integrated circuit chip, the integrated circuit chip including multiple poly-silicon lines including one with a longest length, the method comprising: longitudinally extending each of the multiple poly-silicon lines, except the one with the longest length, by a respective extension line to a length substantially equivalent to the longest length; and positioning a gap to separate each poly-silicon line and a respective extension line, the gap being located outside of and adjacent to an edge of an active area that each poly-silicon line is located over.

The illustrative aspects of the present invention are designed to solve the problems herein described and/or other problems not discussed.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a chip layout with poly-silicon lines extending just beyond the edges of the respective active areas according to prior art.

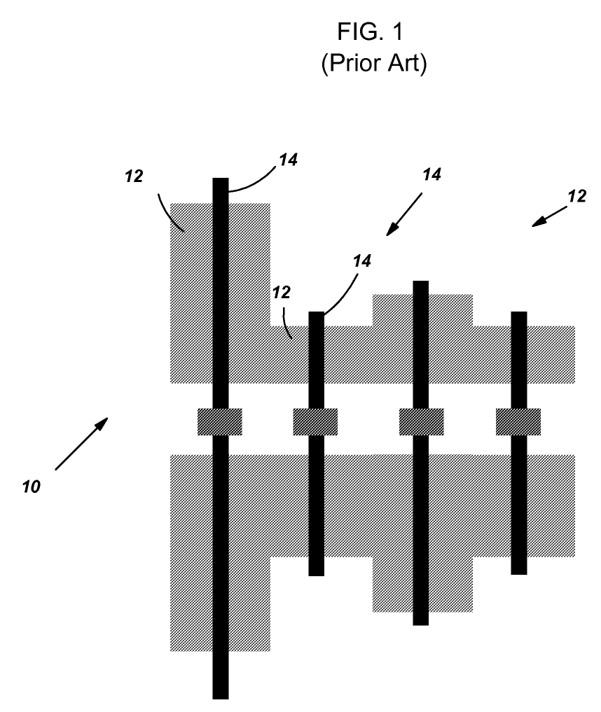

FIG. 2 shows an approach to resolve the ACLV problem caused by the layout of FIG. 1 according to prior art.

FIG. 3 shows a schematic diagram of an integrated circuit (IC) chip layout according to one embodiment of the invention.

FIG. 4 shows a cross-sectional view of the IC chip layout of FIG. 3 according to one embodiment of the invention.

FIG. 5 shows an alternative embodiment of the invention.

FIG. 6 shows a combination of the embodiments of FIGS. 4-5 according to one embodiment of the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION

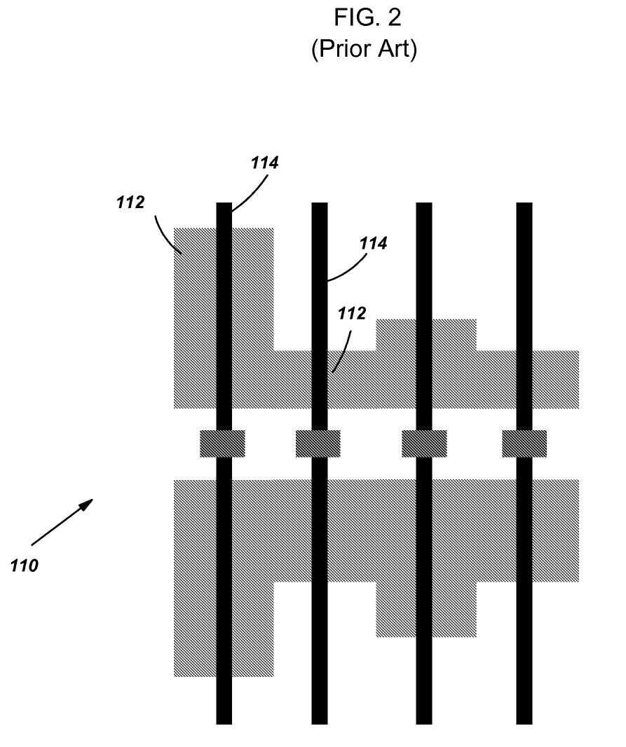

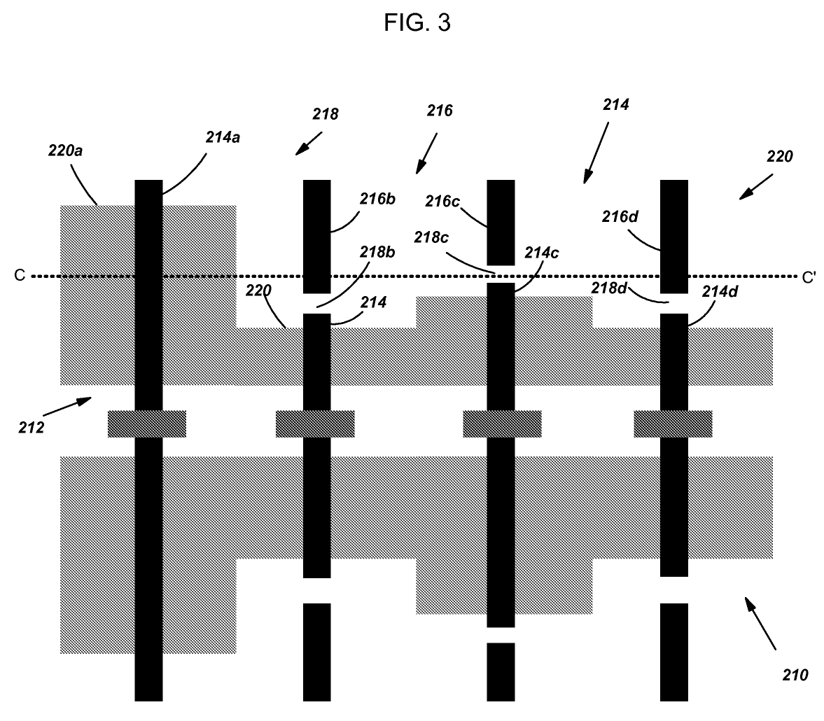

Turning to the drawings, FIG. 3 shows a schematic diagram of an integrated circuit (IC) chip layout 210 according to one embodiment of the invention. As shown in FIG. 3, neighboring poly-silicon lines 214, except poly-silicon line 214a that has the longest length, are longitudinally extended by extension lines 216 to substantially the same length as that of poly-silicon line 214a, similar to the solution shown in FIG. 2. However, each poly-silicon line 214 and the respective extension line 216 are separated by a gap 218, respectively. A gap 218 is located outside of and adjacent to an edge 220 of the respective active area 212. Each poly-silicon line 214 and the respective extension line 216 are of substantially the same conductivity.

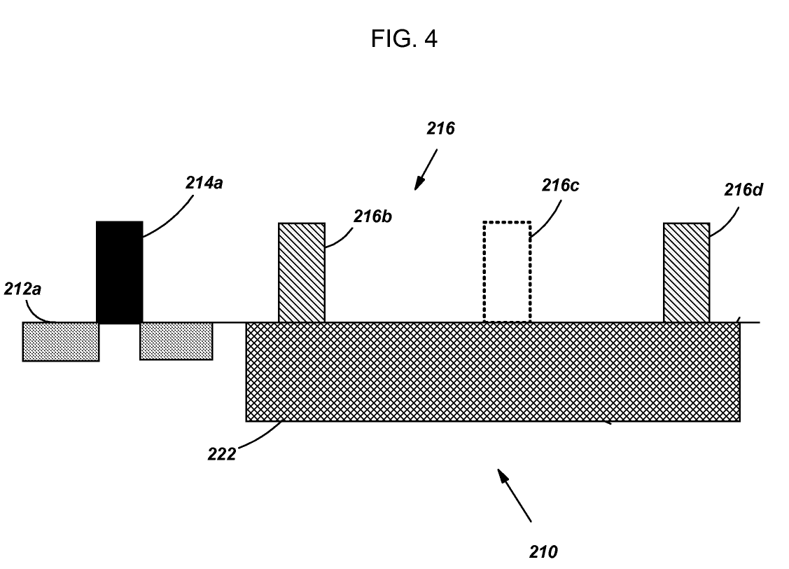

FIG. 4 shows a cross-sectional view of IC chip layout 210 by line CC′ of FIG. 3. As shown in FIG. 4, poly-silicon line 114a, which is not extended, is located above active area 212a; extension line 216b and 216d are located on a non-active area 222, e.g., a shallow trench insulation layer; and extension line 216c, shown in dotted line, looms out of the cross-sectional sphere due to gap 218c (FIG. 3), as line CC′ is across gap 218c (FIG. 3).

Because of gaps 216, layout 210 includes substantially no additional parasitic capacitance, but maintains the advantages of extension lines 216 with respect to ACLV. One reason is that gaps 218 separate poly-silicon lines 214 from extension lines 216 such that a poly-silicon line 214 and the respective extension line 216 are electrically isolated.

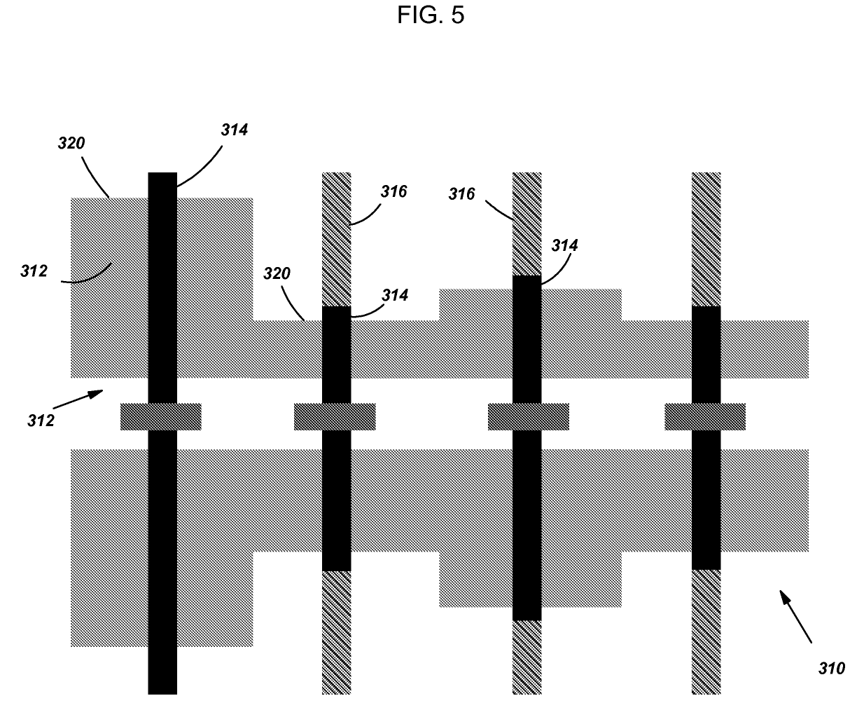

FIG. 5 shows an alternative embodiment of the invention. In FIG. 5, there is no gap between poly-silicon lines 314 and extension lines 316. However, extension lines 316 are of different conductivity than poly-silicon lines 314. For example, extension lines 316 may include more resistance to current than poly-silicon lines 314. It should be appreciated that any method may be used to achieve extension lines 316 of different conductivity than poly-silicon lines 314. For example, doping of extension lines 316 to site of active area 212 may be modified to increase the electrical resistance of extension lines 316 so that the capacitive coupling to poly-silicon lines 314 is decreased. In addition, selectively siliciding only poly-silicon lines 314, not extension lines 316 may also differentiate poly-silicon lines 314 from extensions 316 regarding conductivity. Moreover, extension lines 316 may be fabricated by depositing a non-conductive material that has a similar etching rate as the materials of poly-silicon lines 314.

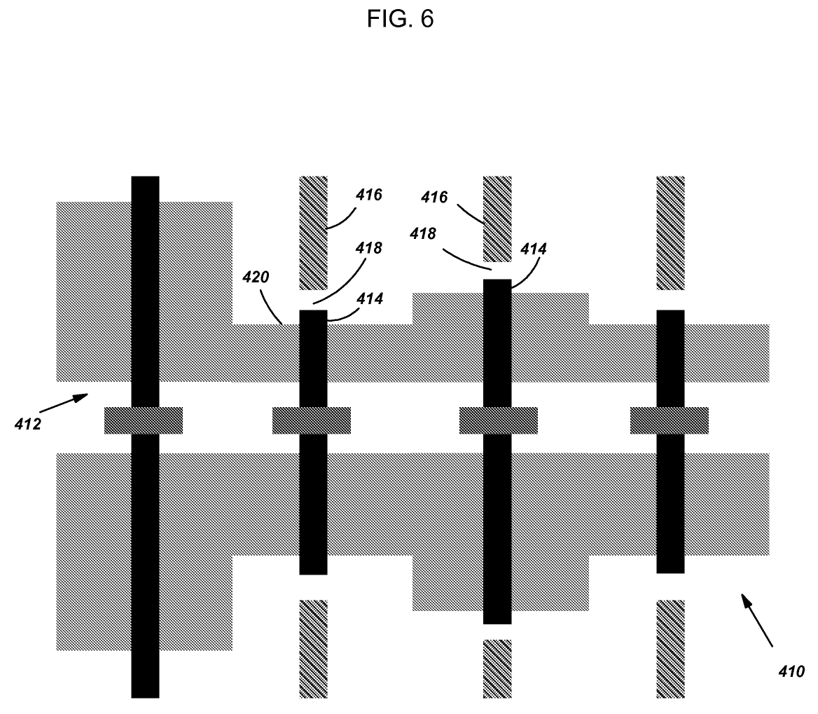

It should be appreciated that embodiments of the invention may be combined, and any combinations are included in the scope of the invention. For example, as shown in FIG. 6, the embodiments of FIGS. 4-5 are combined so that gaps 418 separate poly-silicon lines 414 from extension lines 416, and extension lines 416 are of different conductivity than poly-silicon lines 414.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A semiconductor structure comprising:
a poly-silicon line over an active area of a substrate;
an extension line longitudinally extending from one end of the poly-silicon line; and
a gap separating the poly-silicon line and the extension line, the gap being located outside of and adjacent to an edge of the active area.

2. The structure of claim 1, wherein the poly-silicon line and the extension line are of substantially the same conductivity.

3. The structure of claim 1, wherein the poly-silicon line and the extension line are of different conductivity.

4. The structure of claim 3, wherein the extension line includes more resistance to current than the poly-silicon line.

5. The structure of claim 4, wherein the extension line includes non-conductive materials.

6. The structure of claim 1, further including multiple poly-silicon lines, each of the multiple poly-silicon lines is longitudinally extended by a respective extension line to substantially the same length.

7. The structure of claim 1, further comprising multiple poly-silicon lines including one with a longest length, each of the multiple poly-silicon lines, except the one with the longest length, longitudinally extended by a respective extension line to substantially the longest length.

8. The structure of claim 1, wherein the extension line is located over an insulation trench.

9. An integrated circuit surface layout, the layout comprising:
a poly-silicon line over an active area of a substrate;
an extension line longitudinally extending from one end of the poly-silicon line; and
a gap separating the poly-silicon line and the extension line, the gap being located outside of and adjacent to an edge of the active area.

10. The layout of claim 9, further including multiple poly-silicon lines, each of the multiple poly-silicon lines longitudinally extended by a respective extension line to substantially the same length.

11. The layout of claim 9, further comprising multiple poly-silicon lines including one with a longest length, each of the multiple poly-silicon lines, except the one with the longest length, longitudinally extended by a respective extension line to substantially the longest length.

12. A method for substantially unifying linewidths across an integrated circuit chip, the integrated circuit chip including multiple poly-silicon lines including one with a longest length, the method comprising:
longitudinally extending each of the multiple poly-silicon lines, except the one with the longest length, by a respective extension line to a length substantially equivalent to the longest length; and
positioning a gap to separate each poly-silicon line and a respective extension line, the gap being located outside of and adjacent to an edge of an active area that each poly-silicon line is located over.

13. The method of claim 12, wherein the poly-silicon line and the extension line are of substantially the same conductivity.

14. The method of claim 12, wherein the poly-silicon line and the extension line are of different conductivity.

15. The method of claim 14, wherein the extension line includes more resistance to current than the poly-silicon line.

16. The method of claim 15, wherein the extension line includes non-conductive materials.

17. The method of claim 1, wherein the extension line is located over an insulation trench.
